(19) United States
(12) Patent Application Publication
(10) Pub. No.: US 2010/0211573 A1
(43) Pub. Date: Aug. 19, 2010

(54) INFORMATION PROCESSING UNIT AND INFORMATION PROCESSING SYSTEM

(75) Inventor: Atsuji SEKIGUCHI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/705,805

(22) Filed: Feb. 15, 2010

(30) Foreign Application Priority Data
Feb. 16, 2009 (JP) 2009-33038

(51) Int. Cl. G06F 17/30; G06F 17/00

(52) U.S. Cl. 707/747; 707/E17.052; 707/E17.085

(57) ABSTRACT

A recording medium stores a program that causes a processer to execute a procedure. The procedure includes: calculating registration positions of data based on a total amount of data of existing tables and a hash method, and registering the data at the registration positions, when registering the data in a plurality of tables; adding or deleting a table from the plurality of tables; calculating the registration position of the data based on the total amount of data of the existing tables and the hash method and judging whether data to be referred to is present at the registration position, when data registered in a table is referred to after the table is added or deleted; and when the data to be referred to is not present at the registration position, recalculating the registration position of the data.

### CROSS-REFERENCE TO RELATED APPLICATIONS

This application is based upon and claims the benefit of priority of the prior Japanese Patent Application No. 2009-33038, filed on Feb. 16, 2009, the entire contents of which are incorporated herein by reference.

### FIELD

The present invention relates to an information processing unit, and more particularly, to provision of an information processing unit and an information processing system capable of avoiding the concentration of processes required for the recalculation of hash values while changing the number of tables, for example, when data is managed using the hash method.

### BACKGROUND

Generally speaking, when a computer or the like retrieves data registered in a table, the hash method is widely known as a method for performing retrieval at high speed. As an example of the hash method, a method is known in which a hash value is calculated using a predetermined hash function from the value of a key to which data is linked, and the key and the data linked to the key are registered in a hash table on the basis of the hash value.

An example of the hash method will be described below specifically using a figure. A position (hereafter referred to as a “pointer”) inside a hash table in which a key is registered is registered in a pointer having a value equal to a calculated hash value and is described below.

FIG. 22 is a view illustrating the hash method. First, a process to be performed when a computer registers data will be described, and then a process to be performed when the registered data is retrieved will be described.

As shown in FIG. 22, an example is taken in which a series of keys consisting of four-digit numbers (for example, 1250, 8681, 7542, . . . ) is registered in a hash table 10. Data linked to the keys is not shown for the convenience of description.

First, a hash function h(k) to be used in FIG. 22 is represented by the following expression (1).

h(k)=k % N (1)

where it is assumed that % denotes a residue.

It is assumed that k denotes the value of a key and that N denotes the table size of the hash table 10. The table size corresponds to the amount of memory possessed by the hash table. The table size of the hash table 10 shown in FIG. 22 is set to “10” for the convenience of description.

According to the above-mentioned expression (1), since the computer calculates a hash value as “a residue obtained by dividing the value of a key by 10”, “0” is calculated as the hash value of key “1250”. Hence, the computer registers key “1250” in pointer 0. Similarly, the computer calculates the hash values of the other keys according to expression (1) and registers the values of the other keys in pointers corresponding to the hash values.

On the other hand, when the computer retrieves key “4684”, the computer calculates hash value “4” from key “4684” according to the hash function h(k) represented by expression (1). Hence, by retrieving pointer 4, the computer refers to 4684, whereby the data reference time of the computer becomes substantially O(1): (1 order).

Similarly, with respect to key “8681”, by retrieving pointer 1, the computer refers to 8681, whereby the data reference time of the computer becomes substantially O(1). The number of calculations required to refer to a desired key is defined as a calculation amount (order).

By the use of the hash method as described above, the reference time of the computer becomes substantially O(1), and high-speed data retrieval can be attained.

On the other hand, when keys are registered in given pointers without using the hash method, the reference time of a computer or the like becomes different depending on the key to be retrieved, whereby excessive processing time is required for retrieval in some cases. This will be described below specifically using a figure. FIG. 23 is a view illustrating a problem when keys are registered without using the hash method.

For the convenience of description, in the table 1 shown in FIG. 23, it is assumed that a series of keys consisting of four-digit numbers as in the case of the keys shown in FIG. 22 is used and registered in the table 1 without using the hash method. For example, when retrieving key “3463”, the computer does not know the pointer in the table 1 corresponding to key “3463”, whereby the computer is required to perform searching in the order from the first pointer, i.e., pointer 0.

Hence, since key “3463” is registered in pointer 0, the reference time becomes O(1). However, even in the case of retrieving key “4658”, the computer has no choice but to perform retrieval in the order from the first pointer, i.e., pointer 0, in a way similar to that described above. As a result, the reference time becomes O(8). Furthermore, in the case of retrieving key “3457”, the reference time becomes O(10). Generally speaking, the reference time becomes O(n) when the number of data is n.

On the other hand, as shown in FIG. 22, when the hash method is used, since key “3463” is registered in pointer 3, the computer can refer to key “3463” by first referring to pointer 3, and the reference time becomes O(1).

Furthermore, similarly, key “4658” and key “3457” can also be referred to by first referring to pointer 8 and pointer 7, respectively, and the reference time becomes O(1). Generally speaking, even when the number of data is n, the reference time becomes O(1). In this way, data retrieval can be performed at high speed by using the hash method.

Moreover, since a hash table is held in the main memory of the computer or the like, for the purpose of effectively utilizing the memory resource to be used for the hash table, it is desirable that the size of the table should be changed depending on the number of keys to be used actually.

This is because of the following reasons: if the size of the table is excessive for the number of keys to be handled actually by the computer, it is desirable that the size of the table should be reduced; on the other hand, when new keys are added to a hash table, if the size of the table is insufficient, it is necessary to increase the size of the table.

A technology for expanding the size of the table will be described below by taking two examples. First, as a first example, a technology is known in which when the size of the table is expanded, all the hash values are recalculated depending on the expanded size of the table, and the hash table is restructured.

More specifically, in the case of newly adding key “9999” to the hash table 10 shown in FIG. 22, the amount of memory of the hash table 10 is increased by one, and the size of the table becomes 11.

As a result, the value of N shown in expression (1) becomes 11. The hash values of key “9999” and all the keys having been registered in pointer 0 to pointer 9 are recalculated using expression (1), and the hash table is restructured.

Furthermore, the amount of memory to be consumed for the restructuring of the hash table may become approximately two times the amount of memory consumed before the restructuring of the hash table in some cases.

Next, as a second example, a technology is known in which the size of a hash table is expanded without restructuring the hash table, unlike the case of the above-mentioned first example.

For example, when key “9999” is newly added to the hash table 10 shown in FIG. 22, key “9999” is not added to the hash table 10, but key “9999” is registered in a hash table separately prepared beforehand or in a hash table newly created. (For example, refer to Japanese Patent Application Laid-open Publication No. 8-278894.)

However, the above-mentioned conventional technologies have problems in which waste of the memory resources to be used for the hash table cannot be eliminated and the concentration of recalculation processes required for the restructuring of the hash table cannot be avoided.

For example, a case will be described in which various kinds of data to be used to display the web pages of a WWW (World Wide Web) system are managed using the above-mentioned hash table. It is assumed that the upper limit of the response time required for displaying the web pages is determined by SLA (Service Level Agreement) and is herein set to “3 seconds”. The system is required to be controlled so as to adhere to this SLA.

If restructuring the hash table is requested for the display of the web pages, the calculating device of the WWW system recalculates all hash values. In this case, the processing time required for the recalculation takes long in many cases, and it is not uncommon that the processing time takes more than the above-mentioned 3 seconds. In this case, the processing time exceeds its worst value, resulting in the violation of the SLA.

Furthermore, when the size of a hash table is expanded without restructuring the hash table, the concentration of recalculation processes required for the restructuring of the hash table can be avoided. However, since the hash table added once or the hash table prepared beforehand cannot be eliminated. As a result, the size of the table cannot be changed depending on the number of keys to be registered, and the memory resource is consumed wastefully.

### SUMMARY

According to an aspect of an embodiment of the invention, an information processing unit includes: a registration section that calculates registration positions of data based on a total amount of data of existing tables and a hash method, and that registers the data at the registration positions, when registering adapt in a plurality of tables in the memory device; a table management section for adding or deleting a table among the plurality of tables; a judging section that calculates the registration position of the data based on the total amount of data of the existing tables and the hash method, and that judges whether data to be referred to is present at the registration position, when data registered in a table is referred to after the table is added or deleted using the table management section; and a recalculation section that recalculates the registration position of the data when the data to be referred to is not present at the registration position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view illustrating the general configuration of an embodiment;

FIG. 2 is a functional block diagram illustrating the configuration of an information processing unit according to an embodiment;

FIG. 3 is a view illustrating an example of the data structure of a table management table;

FIG. 4 is a view illustrating an example of the data structure of a table size history table;

FIG. 5 is a view illustrating an example of the data structure of an internal hash table;

FIG. 6 is a view illustrating an example of a data structure possessed by the information processing unit;

FIG. 7 is a view illustrating a process to be performed when data is added before the total table size is expanded;

FIG. 8 is a view illustrating a process to be performed when data is deleted before the total table size is expanded;

FIG. 9 is a view illustrating a process to be performed when the total table size is expanded;

FIG. 10 is a view illustrating a process to be performed when data is added after the total table size is expanded;

FIG. 11 is a view illustrating a process to be performed when key “8” is referred to after the total table size is expanded;

FIG. 12 is a view illustrating a process for moving key 8;

FIG. 13 is a view illustrating a process to be performed when data is deleted after the total table size is expanded;

FIG. 14 is a view illustrating a process for reducing the total table size;

FIG. 15 is a flowchart illustrating a procedure to be executed at the time of data addition;

FIG. 16 is a flowchart illustrating a procedure to be executed at the time of data reference;

FIG. 17 is a flowchart illustrating a procedure to be executed at the time of data movement;

FIG. 18 is a flowchart illustrating a procedure to be executed at the time of data deletion;

FIG. 19 is a flowchart illustrating a procedure to be executed at the time of expanding the total table size;

FIG. 20 is a flowchart illustrating a procedure to be executed at the time of reducing the total table size;

FIG. 21 is a functional block diagram illustrating the configuration of a system for attaining data management using the hash method;

FIG. 22 is a view illustrating the hash method; and

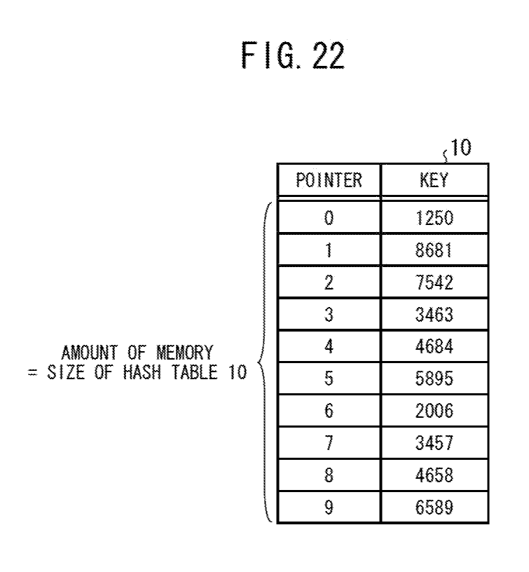

FIG. 23 is a view illustrating a problem when keys are registered without using the hash method.

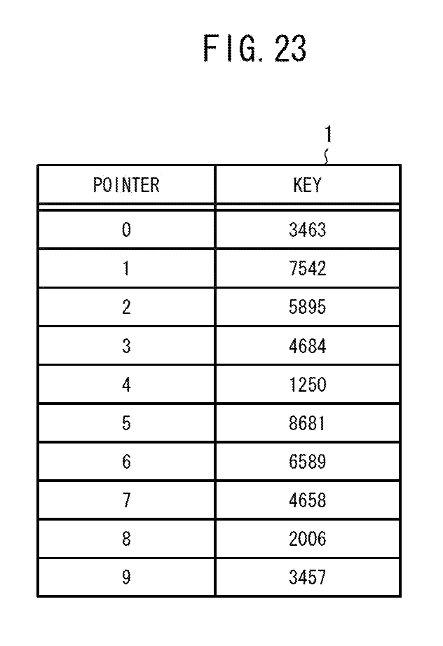

### DESCRIPTION OF EMBODIMENTS

Embodiments of an information processing unit and an information processing system according to the present invention will be described below in detail based on the accompanying drawings. However, the present invention is not limited by these embodiments.

### General Configuration of the Invention

First, the general configurations of the embodiments according to the present invention will be described below. When registering data using a plurality of hash tables, an information processing unit according to an embodiment registers data using an amount of data in existing tables and the hash method.

The information processing unit adds or deletes tables based on the amount of data to be used by the tables. When subsequently referring to the data registered in the tables, the information processing unit calculates the registration positions of the data based on the total amount of data of the tables and the hash method.

The information processing unit retrieves the data to be referred to from the above-mentioned registered positions. When the data cannot be referred to, the information processing unit recalculates the registered positions.

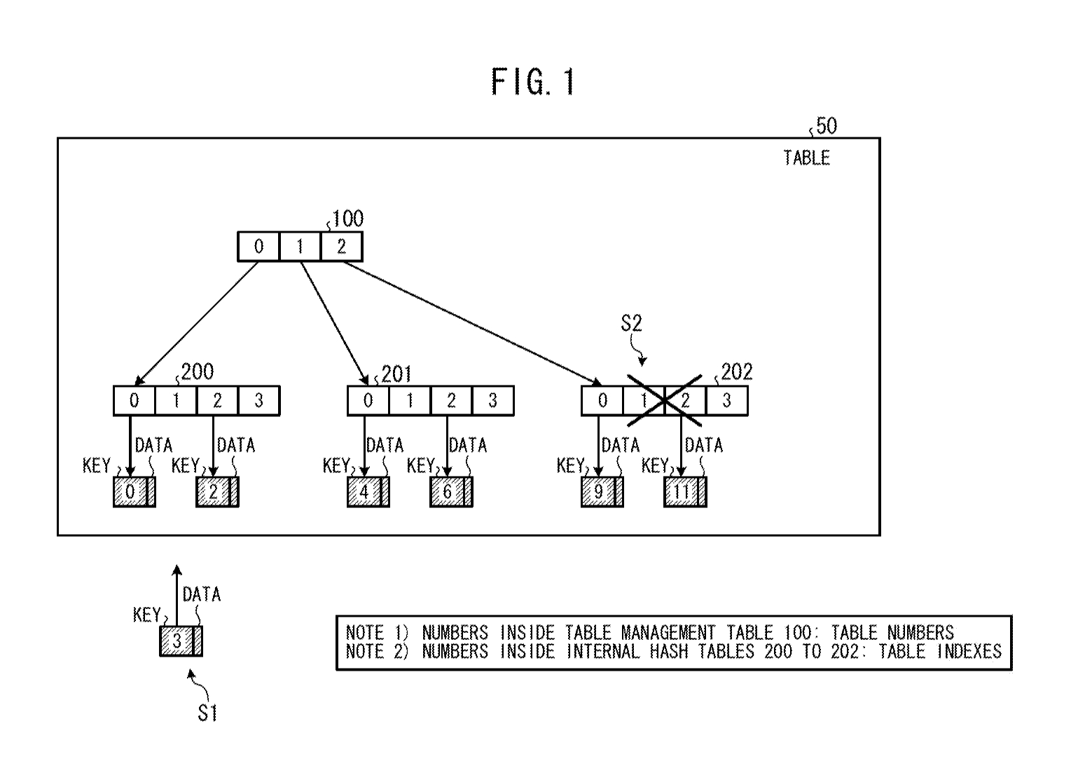

Next, the above-mentioned information processing unit will be described. FIG. 1 is a view illustrating a general configuration of an embodiment. A table 50 in the information processing unit illustrated in FIG. 1 has a plurality of hash tables (internal hash tables 200 to 202) and a table management table 100 for linking the plurality of hash tables.

For the convenience of description, it is assumed that keys “0”, “2”, “4”, “6”, “9” and “11” already exist in the internal hash tables and that the total amount of memory possessed by the above-mentioned plurality of internal hash tables is a “total table size”.

The table management table 100 has table numbers that denote the positions of the internal hash tables. For example, the table number 0 thereof denotes the position of the internal hash table 200, and the table number 1 thereof denotes the position of the internal hash table 201.

The internal hash tables 200 to 202 are tables in which data is stored based on keys, and the tables are registered at positions designated by the above-mentioned table numbers. Furthermore, the internal hash tables have table indexes corresponding to the pointers in which keys are registered. For example, in the case of the internal hash table 200, “0”, “1”, “2” and “3” are table indexes.

When registering a key in the table 50, the information processing unit calculates the hash value corresponding to the value of the key using a specific hash function and obtains the above-mentioned table number and table index based on the calculated hash value. The key is registered in a specific internal hash table.

Next, a process to be performed when data is added to the information processing unit will be described below. For the convenience of description, an example is taken in which data having key “3” is added as an example of data to be registered. First, the information processing unit calculates a hash value from key “3” and the total table size of the table 50.

The information processing unit determines a table number and a table index based on the calculated hash value and determines a position inside the table 50 in which key “3” is registered (at S1).

At this time, when the information processing unit performs registration in the table index 1 of the internal hash table 200, since the other keys having been registered therein do not exist, the information processing unit registers key “3” in the table index 1 of the table.

On the other hand, when the information processing unit performs registration in the table index 2 of the internal hash table 200, since key “2” has already been registered, the information processing unit inserts key “3” between key “2” and the table index 2 and registers key “3” in a list form.

Furthermore, when an extra space for the data to be registered is available in the amount of memory possessed by the table 50, the information processing unit deletes the internal hash table 202, for example (at S2). As a result, the information processing unit reduces the total table size of the table 50 from “12” to “8”.

The information processing unit reregisters key “9” and key “11” having been registered in the internal hash table 202 in the internal hash table 200 or the internal hash table 201.

In addition, after adding key “3” or after deleting the internal hash table 202, when the information processing unit receives an instruction for referring to key “6”, for example, the information processing unit calculates the hash value of key “6” using a specific hash function. The information processing unit determines a table number and a table index from the calculated hash value and determines the reference position of key “6”.

The information processing unit retrieves the table index 2 of the internal hash table 201 and refers to key “6”. However, when the total table size is changed by the addition of key “3” or the deletion of the internal hash table 202, the information processing unit may not retrieve key “3” in some cases.

In this case, the information processing unit reads the total table size from a table size history table while tracing back to the time before the change of the table size, performs processes ranging from the recalculation of the hash value of key “3” and the determination of a table index again, and determines the reference position of key “3”. The information processing unit retrieves key “3” again.

The information processing unit repeats this operation until key “3” is found or the table size history table cannot be traced back. When the table size is changed as described above, the number of hash value calculations increases when a reference instruction is processed. However, the reference time still does not become proportional to the amount of data, but is nearly equal to O(1).

As described above, the information processing unit according to the embodiment has a plurality of hash tables in which keys to which data is linked are registered and a management table for linking the plurality of hash tables and changes the total table size depending on the number of keys to be registered.

Furthermore, the information processing unit does not immediately perform the recalculation of all the hash values accompanied by the change in the total table size and does not restructure the hash tables. The recalculation of the hash values is performed for the keys having been referred to.

Hence, the information processing unit changes the total table size of the hash tables depending on the amount of data to be used in the tables. As a result, wasteful consumption of the memory resource to be used for the hash tables may be reduced if not eliminated.

Moreover, since the information processing unit does not immediately perform the recalculation of the hash values, the concentration of processes required for the recalculation of the hash values may be avoided, and the worst value of the processing time determined by the above-mentioned SLA may be reduced.

### Embodiment

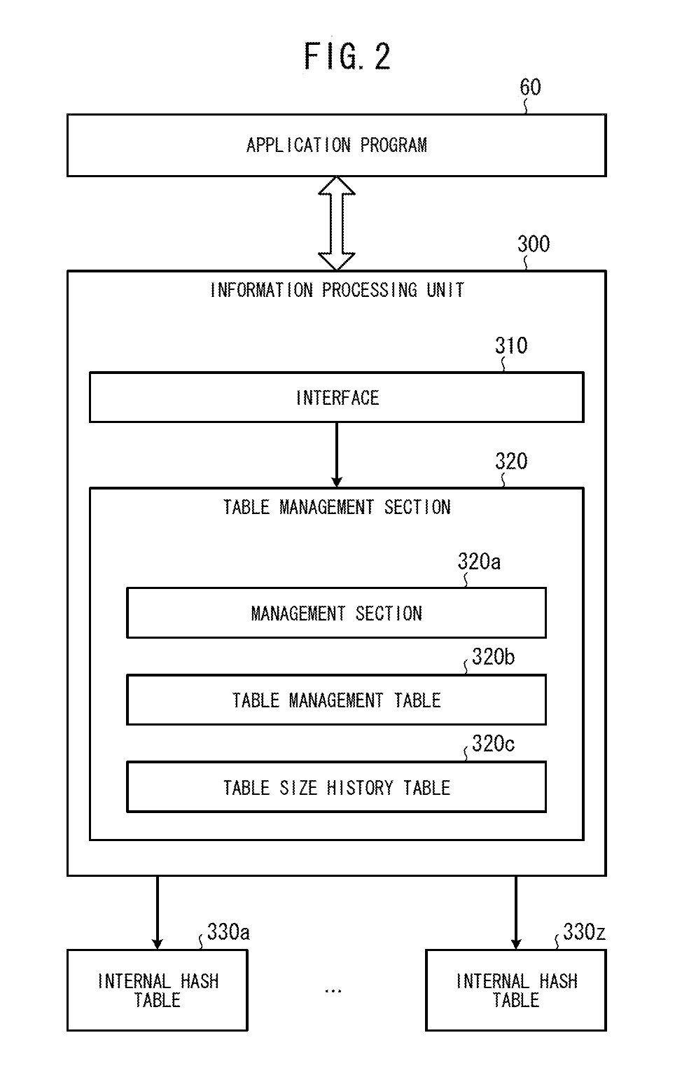

Next, the configuration of the information processing unit according to an embodiment will be described below. FIG. 2 is a functional block diagram illustrating the configuration of the information processing unit according to an embodiment. For the convenience of description, the configuration is described below by taking an example in which an information processing unit 300 illustrated in FIG. 2 is used as a program inside a computer.

After receiving instructions for reference, addition, etc. of various kinds of data, the information processing unit 300 illustrated in FIG. 2 registers data in hash tables using the hash method and changes the total table size depending on the number of the keys for identifying the data. A plurality of hash tables exist inside the information processing unit 300 and are linked to a specific table described later.

The information processing unit 300 has an interface 310, a table management section 320, and internal hash tables 330a to 330z. A device for executing an application program 60 serves as programs for executing instructions for registration, reference, addition, etc. of keys and for executing instructions for the change, etc. of the total table size for the information processing unit 300.

The interface 310 is an interface for performing processes in accordance with instructions for reference, addition, etc. of various kinds of keys from the application program 60 to the information processing unit 300. For example, when an instruction for referring to the data associated with key “0” is input to the interface 310 from the application program 60, the interface 310 issues an instruction for referring to key “0” to the table management section 320.

The table management section 320 is a management section for performing processes in accordance with various kinds of instructions input from the interface 310 and for changing the total table size depending on the number of keys to be registered in the internal hash tables 330a to 330z.

Furthermore, the table management section 320 has a management section 320a, a table management table 320b, and a table size history table 320c.

The management section 320a is a unit for managing table numbers possessed by the table management section 320b and for managing the data of the total table size possessed by the table size history table 320c in accordance with various kinds of instructions input from the interface 310.

Furthermore, the management section 320a performs the hash calculations of keys registered in the internal hash tables 330a to 330z, performs the reference and deletion of keys, and performs the addition and deletion of the internal hash tables.

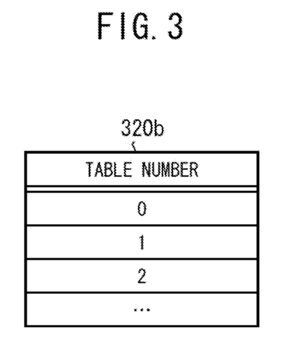

The table management table 320b is a table for linking the internal hash tables 330a to 330z, and a data structure thereof is described. FIG. 3 is a view illustrating an example of the data structure of the table management table.

The table management table 320b illustrated in FIG. 3 corresponds to the table management table 100 illustrated in FIG. 1, and the management section 320a performs data renewal, etc. The table management table 320b has a “table number”.

“Table number” denotes the pointer of each of the internal hash tables 330a to 330z. For example, table number 0 denotes the pointer of the internal hash table 330a, and table number 1 denotes the pointer of the internal hash table 330b.

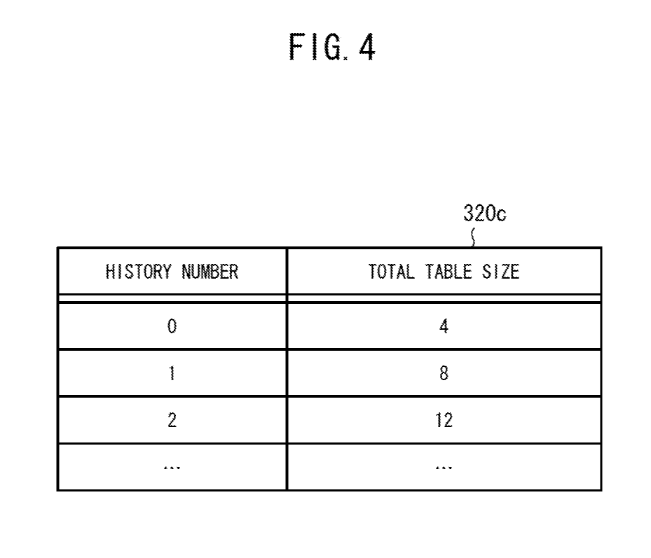

The table size history table 320c is a table in which the history of the total amount of memory (corresponding to the above-mentioned total table size) of the internal hash tables 330a to 330z is stored, and the management section 320a performs renewal, etc. of data. A specific data structure is described using FIG. 4. FIG. 4 is a view illustrating an example of the data structure of the table size history table.

The table size history table 320c illustrated in FIG. 4 has a “history number” and a “total table size”. “History number” denotes a number for managing the history of the total table size of the information processing unit 300. It is assumed that the initial value is 0. Each time one internal hash table is added, the history number increases by one, such as “1”, “2”, . . . .

“Total table size” denotes the total amount of memory of the internal hash tables 330a to 330z possessed by the information processing unit 300 as described above. It is assumed that the amount of memory possessed by a single internal hash table (hereafter referred to as a “unit table size”) is “4”.

In this case, each time one internal hash table is added, the amount of memory “4” possessed by the unit table size is added, and the total table size increases by four, such as “8”, “12”, . . . .

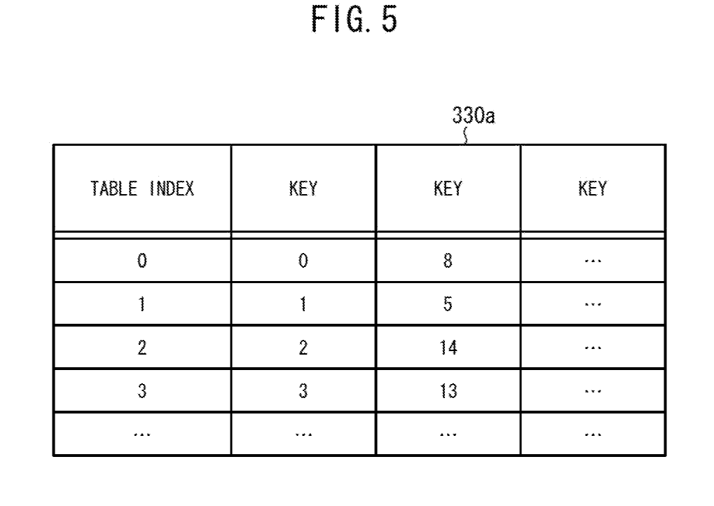

The internal hash tables 330a to 330z are hash tables in which data is stored based on keys. The specific data structure thereof is described below by taking the internal hash table 330a as an example. FIG. 5 is a view illustrating an example of the data structure of the internal hash table.

It is assumed that the internal hash table 330a illustrated in FIG. 5 corresponds to the internal hash table 200 illustrated in FIG. 1 (similarly, it is also assumed that the internal hash table 330b and the subsequent tables correspond to the internal hash tables illustrated in FIG. 1).

Furthermore, the internal hash table 330a has a “table index”, and various kinds of keys are registered in the table index. The control section 320a performs data management. For the convenience of description, data associated with each key is not illustrated.

Each table index denotes a pointer in the internal hash table 330a, and a key is registered in the pointer. Various kinds of data are associated with the key.

For example, when a pointer in which key “0” is registered is determined at the table index 0 of the internal hash table 330a, the management section 320a registers key “0” in the table index 0 of the internal hash table 330a.

When the control section 320a further registers key “8”, and when a pointer in which key “8” is registered is determined at the table index 0 of the table, the control section 320a registers key “8” so that key “0” and key “8” are arranged in a list form.

Although it is assumed that the value of each key is an integer in FIG. 5 for the convenience of description, the value of each key is not limited to an integer, but may be a character string, such as “Hello” or “Object 1”. In this case, the index of the internal hash table is determined based on the value of the key denoted by the data structure of “Hello” or “Object 1” and a hash function. The management section 320a registers the data in the specific table index.

As described above, when data is added in the embodiment, and when existing data is present in a table index serving as a registration position, it is assumed that the data is added using the so-called chain method.

Hence, even if data has already been registered in the index of the internal hash table in which registration is to be performed, the management section 320a adds registration data in a list form. As a result, one kind of hash function may be used for the management section 320a.

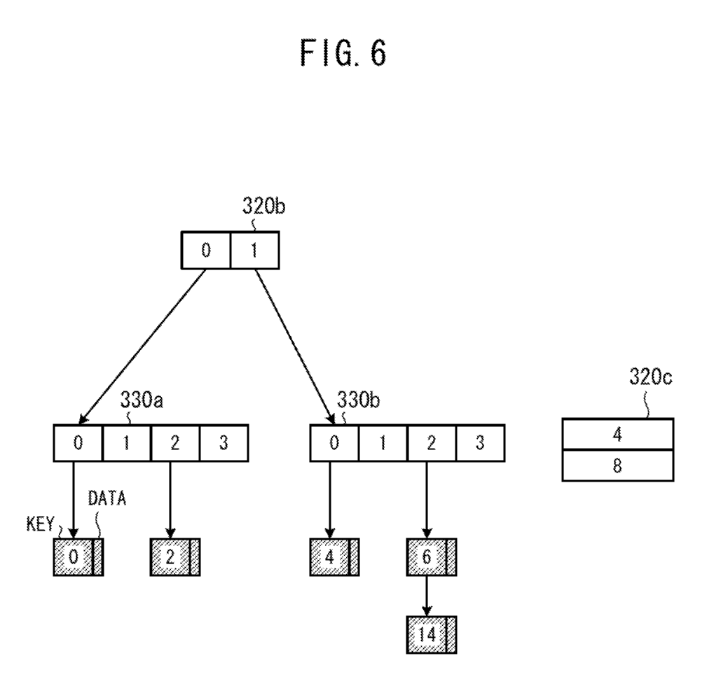

Next, data processing to be performed by the information processing unit 300 illustrated in FIG. 2 will be described below. For the convenience of description, it is assumed that the information processing unit 300 has data illustrated in FIG. 6 described below in advance.

As described above, the amount of memory of each internal hash table possessed by the information processing unit 300 is used as a unit table size, and it is assumed that the this unit table size is “4” for the sake of convenience.

Moreover, a hash function H(k) to be used when the management section 320a obtains a hash value from each key “k” (k is a number), a function h1(x) to be used when the management section 320a obtains a table number, and a function h2(x) to be used when the management section 320a obtains a table index are determined as the following expressions (2) to (4), respectively.

H(k)=k % N (2)

where % denotes a residue, k denotes the value of a key, and N denotes the total table size;

h1(x)=x/n (3)

where x is a hash value obtained by expression (2), and n denotes a unit table size;

h2(x)=x % n (4)

where % denotes a residue, x is a hash value obtained by expression (2), and n denotes a unit table size.

FIG. 6 is a view illustrating an example of a data structure possessed by the information processing unit. The total table size of the information processing unit 300 illustrated in FIG. 6 is “8”, and keys “0” and “2” are registered in the table indexes 0 and 2 of the internal hash table 330a.

Furthermore, key “4” is registered in the table index 0 of the internal hash table 330b, and keys “6” and “14” are registered in the table index 2 of the internal hash table 330b.

Moreover, the internal hash table 330a and the internal hash table 330b are registered in the table numbers 0 and 1 of the table management section 320b, respectively. What is more, “4” and “8” are stored in the table size history table 320c.

(Data Addition Before Expanding Table Size)

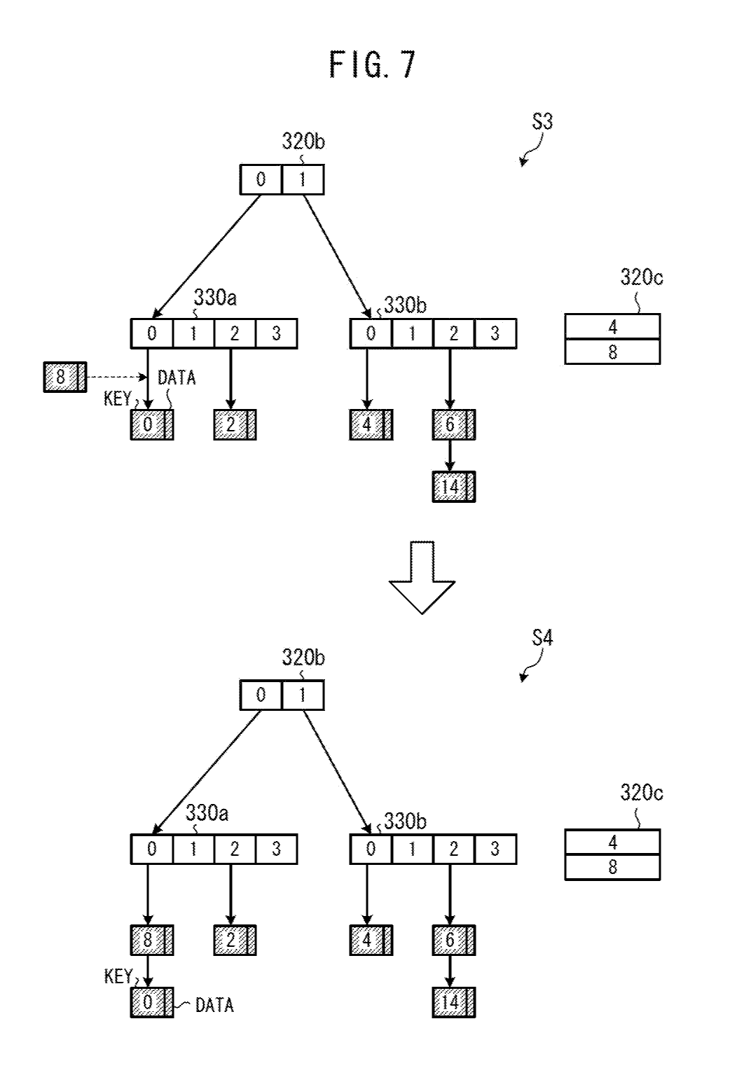

First, when key “8” is added to the data structure illustrated in FIG. 6, a process to be performed by the information processing unit 300 will be described below. FIG. 7 is a view illustrating the process to be performed when data is added before the total table size is expanded.

First, the management section 320a illustrated in FIG. 2 receives an instruction for adding key “8” from the above-mentioned application program 60 and calculates a position in which key “8” is added according to expressions (2) to (4). This calculation process will be described below.

First, the management section 320a obtains the hash value corresponding to key “8” according to expression (2) using key “8” and total table size “8”. The management section 320a calculates “0” as the hash value corresponding to key “8”.

Next, the management section 320a obtains the table number corresponding to hash value “0” according to expression (3) using hash value “0” obtained according to expression (2) and unit table size “4”. The management section 320a calculates “0” as the table number corresponding to hash value “0”.

Subsequently, the management section 320a obtains the table index corresponding to the table number 0 according to expression (4) using hash value “0” obtained according to expression (2) and unit table size “4”. The management section 320a calculates “0” as the table index corresponding to the table number 0.

Hence, the management section 320a determines the position in which key “8” is added at the table index 0 of the internal hash table 330a and retrieves the index of the table (at S3).

In this case, since data (key “0”) already exists in the table index 0 of the internal hash table 330a, the management section 320a inserts key “8” between the internal hash table 330a and key “0” and registers key “8” in a list form (at S4).

As illustrated at S4, for the convenience of the linear search of the list, the management section 320a registers key “8” at the table index 0 of the internal hash table 330a. However, key “8” may be registered behind the already existing key “0” in a list form.

(Data Reference Before Expanding Table Size)

Next, a process to be performed when the management section 320a refers to key “8” will be described below. First, the management section 320a receives an instruction for referring to key “8” from the above-mentioned application program 60 and performs the calculation executed when key “8” was added according to expressions (2) to (4) for key “8”.

As a result, the reference position of key “8” is determined uniquely at the table index 0 of the internal hash table 330a. This is performed similarly even if key “8” is connected in the list form as illustrated in FIG. 7.

The management section 320a retrieves key “8” from the table index 0 of the internal hash table 330a. In this case, as illustrated in FIG. 7, since key “8” is registered in the table index 0 in the list form, the management section 320a refers to key “8” and returns the referred data to the interface 310.

(Deletion Before Expanding Table Size)

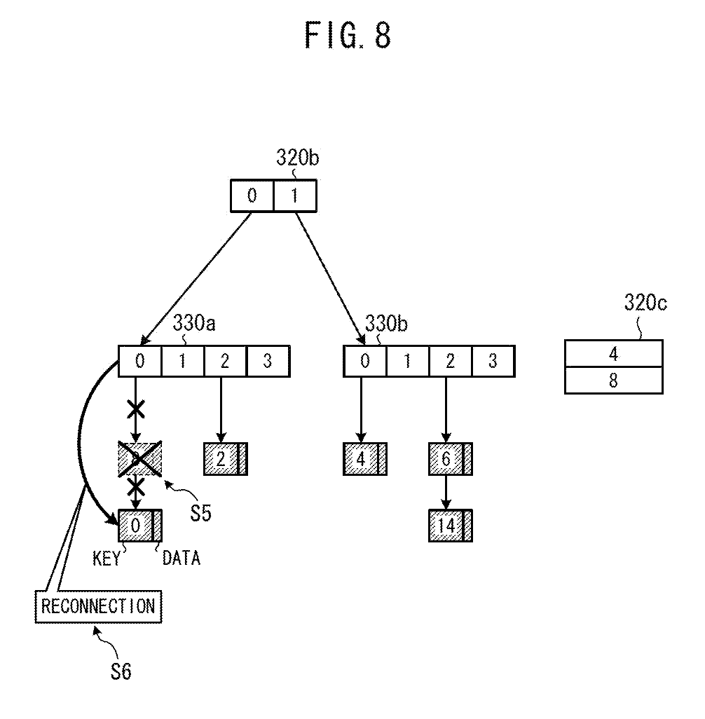

Next, a process to be performed when key “8” described referring to FIG. 7 is deleted will be described. FIG. 8 is a view illustrating the process to be performed when data is deleted before the total table size is expanded.

First, the management section 320a receives an instruction for deleting key “8” from the above-mentioned application program 60 and performs the calculation executed when key “8” was added according to expressions (2) to (4).

As a result, since the reference position of key “8” to be deleted is determined at the table index 0 of the internal hash table 330a, the management section 320a retrieves key “8” from the table index 0 of the table.

In this case, as illustrated in FIG. 8, since key “8” has been registered in the table index 0 of the internal hash table 330a in the list form, the management section 320a refers to key “8” from the table index 0 of the table and deletes key “8” (at S5).

Next, the management section 320a reconnects the pointer indicated by the table index 0 of the internal hash table 330a to key “0” and frees the memory used for key “8” and the data corresponding to key “8” (at S6).

On the other hand, when data is not linked to the key subsequent to key “8” to be deleted, the management section 320a frees the memory used for key “8” and the data corresponding to key “8”.

(Expansion of Total Table Size)

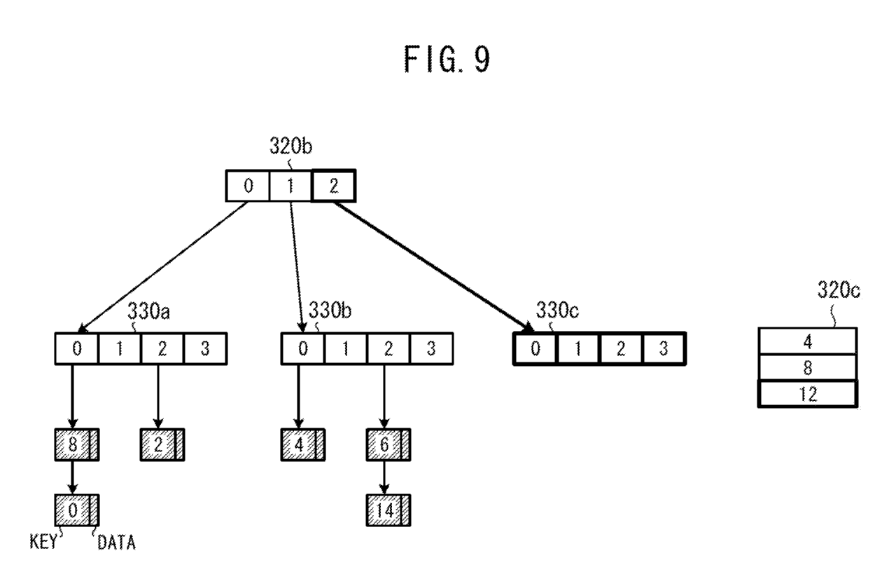

Next, a process to be performed when the total table size is expanded will be described below. FIG. 9 is a view illustrating the process to be performed when the total table size is expanded.

For example, the management section 320a receives an instruction for expanding the total table size from the above-mentioned application program 60 and creates new table number “2” behind the table number 1 in the table management table 320b.

The management section 320a creates an internal hash table 330c having unit table size “4” and links the created internal hash table to the newly added table number 2.

Furthermore, to the end of the table size history table 320c, the management section 320a adds “12” obtained by adding unit table size “4” to the previous total table size “8”.

The case in which an instruction is received from the above-mentioned application program 60 and the total table size is expanded is taken as an example and described above. However, when, for example, the management section 320a judges that the total table size is insufficient considering the number of keys stored in the internal hash tables, it is assumed that the total table size may be expanded.

(Data Addition after Expanding Total Table Size)

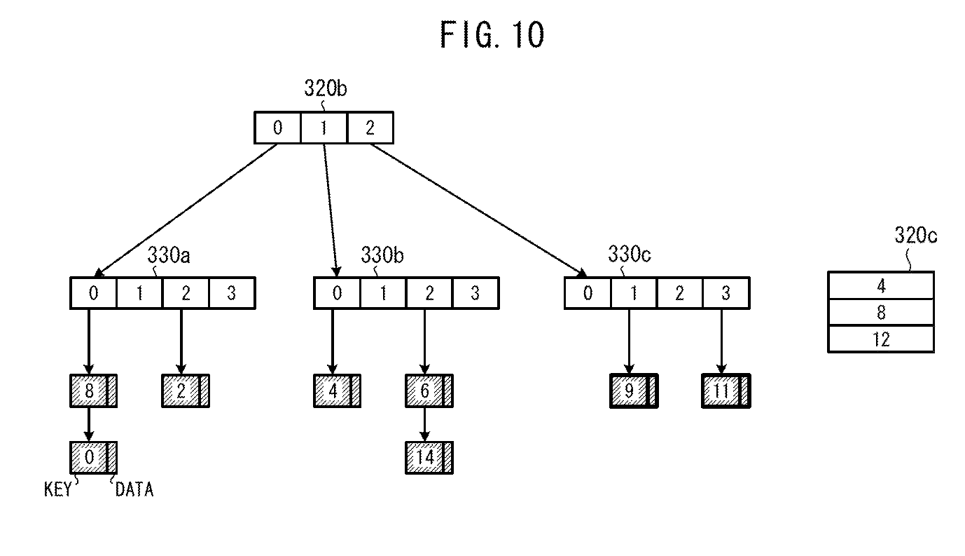

Next, processes to be performed after the total table size is expanded will be described below. As an example, a process to be performed when key “9” and key “11” are added to the information processing unit 300 will be described below. FIG. 10 is a view illustrating a process to be performed when data is added after the total table size is expanded.

First, the management section 320a receives key “9” and key “11” from the above-mentioned application program 60 and obtains the hash values of key “9” and key “11” according to expression (2). It is assumed that the total table size to be used in expression (2) is “12”.

As a result, the management section 320a calculates hash value “9” corresponding to key “9” and calculates hash value “11” corresponding to key “11”.

The management section 320a obtains table numbers for hash value “9” and hash value “11” according to expression (3). As a result, each of the table numbers corresponding to hash value “9” and hash value “11” is calculated as “2”.

Subsequently, the management section 320a obtains the table indexes corresponding to hash value “9” and hash value “11” according to expression (4). As a result, the table indexes corresponding to hash value “9” and hash value “11” are calculated as table indexes “1” and “3” of the information processing unit 330c, respectively.

Hence, key “9” is registered in the table index 1 of the internal hash table 330c, and key “11” is registered in the table index 3 of the table.

(Data Reference after Expanding Table Size)

Next, a process to be performed when the management section 320a refers to key “9” added as illustrated in FIG. 10 will be described below. First, the management section 320a receives an instruction for referring to key “9” from the above-mentioned application program 60 and obtains the hash value corresponding to key “9” according to expression (2) using key “9” and total table size “12”. The management section 320a calculates “9” as the hash value corresponding to key “9”.

The management section 320a obtains the table number corresponding to hash value “9” according to expression (3) using hash value “9” obtained according to expression (2) and unit table size “4”. Furthermore, the management section 320a calculates “2” as the table number corresponding to hash value “9”.

The management section 320a obtains the table index corresponding to the table number 2 according to expression (4) using hash value “9” obtained according to expression (2) and unit table size “4”. Furthermore, the management section 320a calculates “1” as the table index corresponding to the table number 2.

Hence, the management section 320a determines the reference position of key “9” at the table index 1 of the internal hash table 330c and retrieves key “9”. In this case, as illustrated in FIG. 10, the management section 320a refers to key “9” at the table index 1 of the table and returns the referred data to the interface 310.

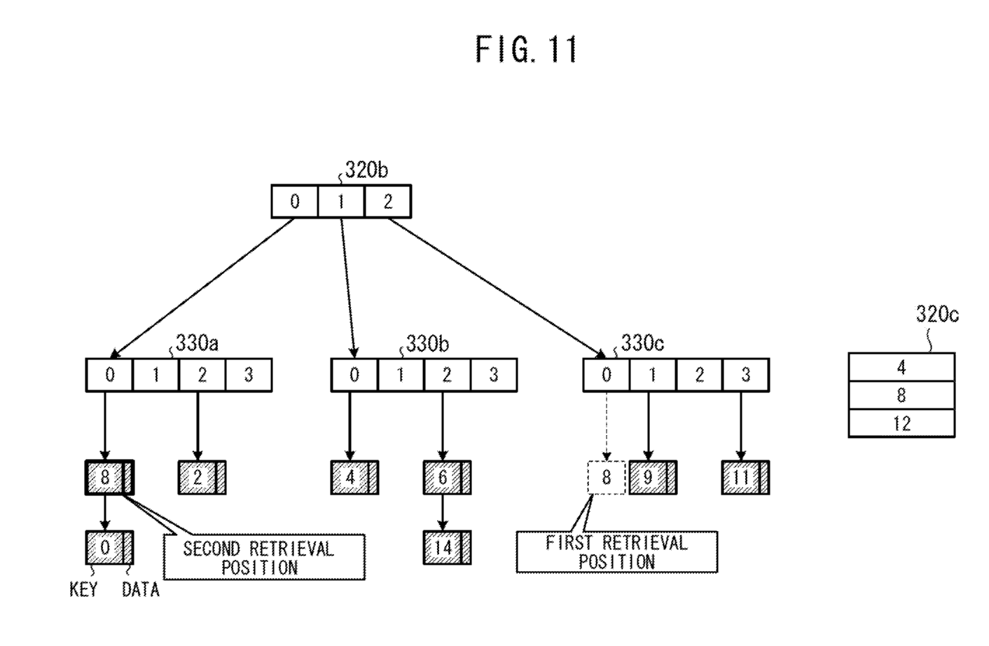

Next, a process to be performed when key “8” is referred to after the total table size is expanded will be described below. FIG. 11 is a view illustrating the process to be performed when key “8” is referred to after the total table size is expanded.

First, the management section 320a receives an instruction for referring to key “8” from the above-mentioned application program 60 and obtains the hash value corresponding to key “8” using key “8” and total table size “12”. The management section 320a calculates “8” as the hash value corresponding to key “8”.

Next, the management section 320a obtains the table number corresponding to key “8” according to expression (3) using hash value “8” according to expression (2) and unit table size “4”. Furthermore, the management section 320a calculates “2” as the table number corresponding to hash value “8”.

The management section 320a obtains the table index of the internal hash table corresponding to the table number 2 according to expression (4) using hash value “8” obtained according to expression (2) and unit table size “4”. Furthermore, the management section 320a calculates “0” as the table index corresponding to the table number 2. Furthermore, the management section 320a calculates “0” as the table index corresponding to the table number 2.

Hence, the management section 320a determines the reference position of key “8” at the table index 0 of the internal hash table 330c and refers to key “8”. In this case, the management section 320a cannot refer to key “8” at the table index 0 of the table.

The management section 320a refers to the table size history table 320c and recalculates the hash value corresponding to key “8” using total table size “8” that was used immediately before total table size “12”.

Hence, the management section 320a obtains the hash value corresponding to key “8” according to expression (2) using key “8” and total table size “8”. The management section 320a calculates “0” as the hash value corresponding to key “8”.

The management section 320a obtains the table number corresponding to key “8” according to expression (3) using hash value “0” obtained according to expression (2) and unit table size “4”. The management section 320a calculates “0” as the table number corresponding to hash value “0”.

The management section 320a obtains the table index corresponding to the table number 2 according to expression (4) using hash value “0” obtained according to expression (2) and unit table size “4”. Furthermore, the management section 320a calculates “0” as the table index corresponding to the table number 0.

Hence, the management section 320a determines the reference position of key “8” at the table index 0 of the internal hash table 330a and retrieves key “8”. In this case, the management section 320a refers to key “8” at the table index 0 of the internal hash table 330a and returns the referred data to the interface 310.

When key “8” is referred to in FIG. 11, the management section 320a reregisters the registration position of key “8” at the reference position obtained when the total table size is the newest value, 12, by using the table size history table 320c.

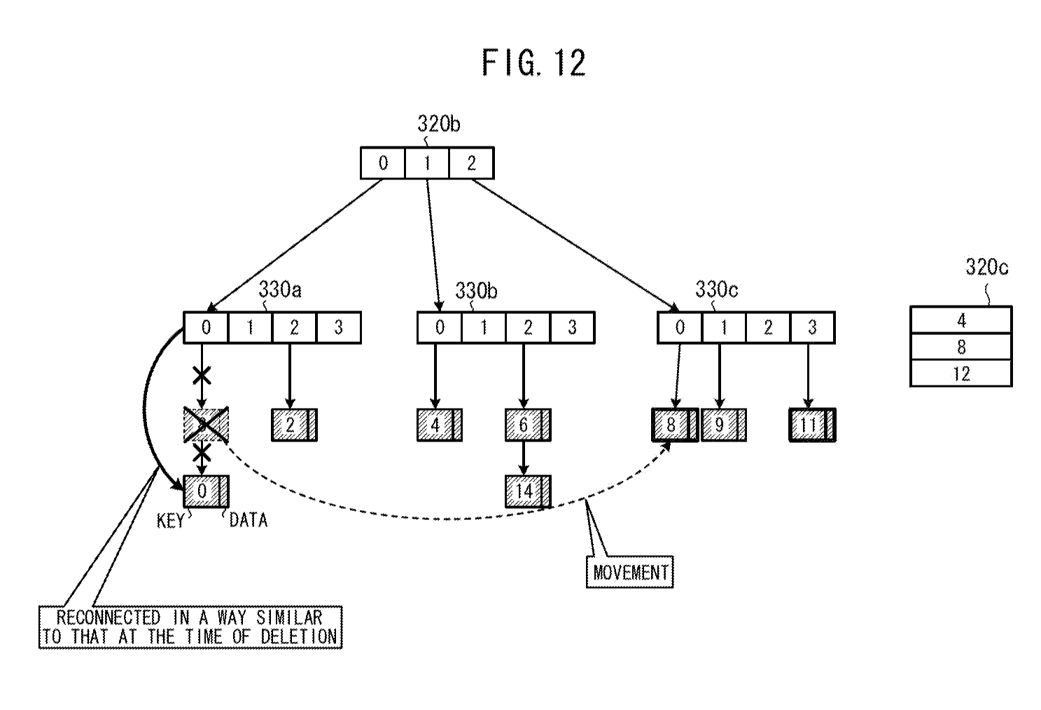

This will be described below. FIG. 12 is a view illustrating a process for moving key “8”. As illustrated in FIG. 12, the management section 320a recalculates the hash value according to expressions (2) to (4) based on the referred key “8” and total table size “12” registered at the end of the table size history table 320c.

The management section 320a determines the table number and the table index corresponding to key “8”. In this case, the reference position of key “8” is determined at the index 0 of the internal hash table 330c.

The management section 320a moves key “8” from the index 0 of the internal hash table 330a to the calculated index 0 of the internal hash table 330c.

As in the case when data is deleted, the management section 320a reconnects the pointer indicated in the table index 0 to key “0” linked so as to be subsequent to key “8” to be deleted and frees the memory used for key “8” and the data corresponding to key “8”.

When key “8” is unable to be referred to in the case described above, the reference position (for example, the table index 0 of the internal hash table 330c) is stored. When the reference to key “8” is done successfully thereafter, key “8” may be reregistered based on the stored retrieval position.

Since the management section 320a reregisters key “8” in accordance with the newest total table size, the management section 320a does not need to recalculate the hash value corresponding to key “8” when referring to key “8” again, whereby the time for retrieval may be reduced.

The case in which the management section 320a performs reference using total table size “8” that is used immediately before total table size “12” is described above. However, when the reference is unable to be performed even when total table size “8” is used, the management section 320a performs operations ranging from the recalculation of the hash value to the determination of the table index using total table size “4” that is used immediately before total table size “8” and retrieves data.

When data is unable to be referred to even if total table size “4” is used, the management section 320a returns a response to the interface 310 to the effect that data is unable to be referred to.

(Data Deletion after Expanding Total Table Size)

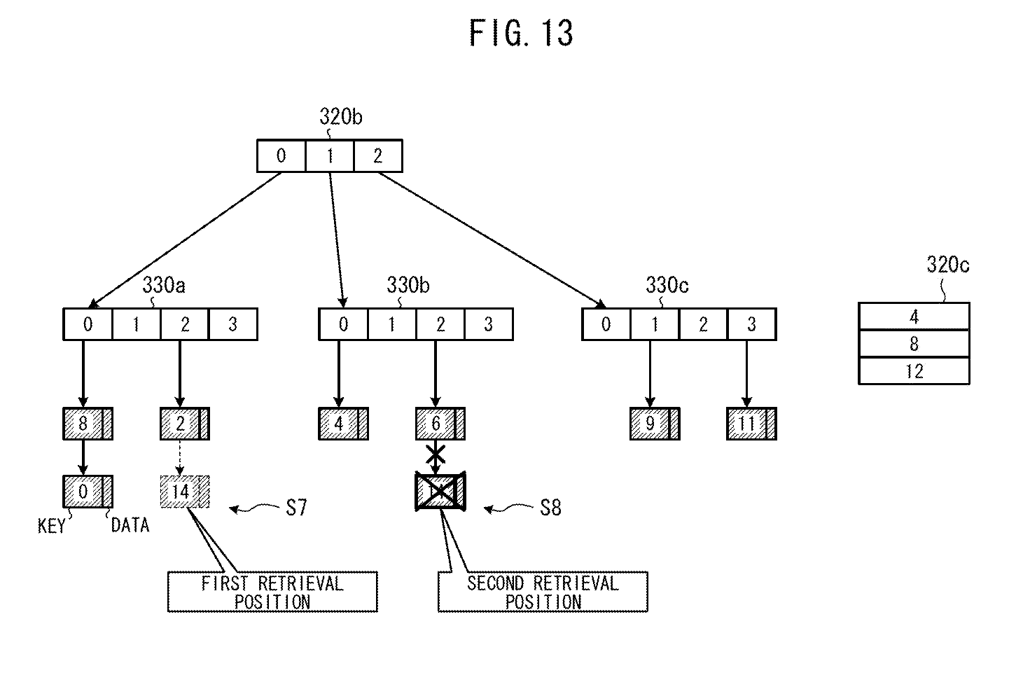

Next, a process to be performed when data is deleted after the total table size is expanded will be described below. FIG. 13 is a view illustrating the process to be performed when data is deleted after the total table size is expanded. For the convenience of description, a case in which key “9” and key “14” are deleted is taken as an example and described.

First, a case in which key “9” is deleted is taken as an example. The management section 320a receives an instruction for deleting key “9” from the above-mentioned application program 60 and refers to key “9” to be deleted. At this time, the management section 320a calculates the reference position of key “9” according to expressions (2) to (4).

The management section 320a determines the reference position of the key at the table index 1 of the internal hash table 330c and refers to key “9”. Since the management section 320a may refer to key “9” at the table index 1 of the table, the management section 320a deletes key “9”.

Subsequently, a case in which key “14” is deleted is taken as an example. First, the management section 320a receives an instruction for deleting key “14” from the above-mentioned application program 60 and refers to key “14” to be deleted.

At this time, the management section 320a obtains the hash value corresponding to key “14” according to expression (2) using key “14” and total table size “12”. The management section 320a calculates “2” as the hash value corresponding to key “14”.

The management section 320a obtains the table number corresponding to key “14” according to expression (3) using hash value “2” obtained according to expression (2) and unit table size “4”. Furthermore, the management section 320a calculates “0” as the table number corresponding to hash value “2”.

The management section 320a obtains the table index corresponding to the table number 0 according to expression (4) using hash value “2” obtained according to expression (2) and unit table size “4”. Furthermore, the management section 320a calculates “2” as the table index corresponding to the table number 0.

Hence, the management section 320a determines the reference position of key “14” at the table index 2 of the internal hash table 330a and refers to key “14”. In this case, the management section 320a cannot refer to key “14” at the table index 2 of the table (at S7).

The management section 320a refers to the table size history table 320c and recalculates the hash value corresponding to key “14” using total table size “8” that was used immediately before total table size “12”.

Hence, the management section 320a obtains the hash value corresponding to key “14” according to expression (2) using key “14” and total table size “8”. The management section 320a calculates “6” as the hash value corresponding to key “14”.

The management section 320a obtains the table number corresponding to key “14” according to expression (3) using hash value “6” obtained according to expression (2) and unit table size “4”. The management section 320a calculates “1” as the table number corresponding to hash value “6”.

The management section 320a obtains the table index corresponding to the table number 1 according to expression (4) using hash value “6” obtained according to expression (2) and unit table size “4”. Furthermore, the management section 320a calculates “2” as the table index corresponding to table number “1”.

Hence, the management section 320a determines the reference position of key “14” at the table index 2 of the internal hash table 330b and retrieves key “14”. In this case, the management section 320a refers to key “14” at the table index 2 of the internal hash table 330b and deletes key “14”. The management section 320a frees the memory used for key “14” and the data corresponding to key “14” (at S8).

(Reduction of Total Table Size)

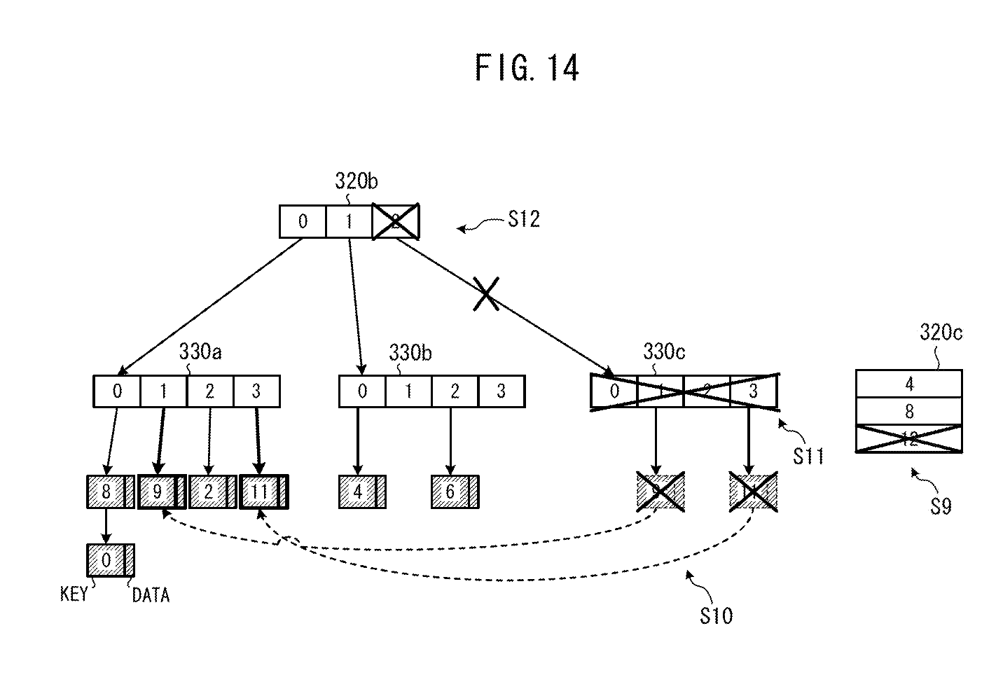

Next, a process to be performed when the total table size is reduced will be described below. FIG. 14 is a view illustrating the process for reducing the total table size. A case in which the information processing unit 300 reduces the total table size after the total table size is expanded as described referring to FIG. 9 will be described below.

First, the management section 320a receives an instruction for reducing the total table size from the above-mentioned application program 60, deletes the newest table size history “12” from the table size history table 320c, and sets the newest total table size to “8” (at S9).

The management section 320a moves key “9” and key “11” registered in the internal hash table 330c linked to table number “2” to the internal hash table 330a or the internal hash table 330b not to be deleted (at S11).

In this case, the management section 320a obtains the hash values corresponding to key “9” and key “11” using the respective key values and total table size “8”. The management section 320a calculates “1” as the hash value corresponding to key “9” and “3” as the hash value corresponding to key “11”.

The management section 320a obtains the table numbers corresponding to hash value “1” and hash value “3” according to expression (3). Subsequently, the management section 320a calculates “0” as the table number corresponding to hash value “1” and similarly calculates “0” as the table number corresponding to hash value “3”.

The management section 320a obtains the table indexes corresponding to the table number 0 for hash value “1” and hash value “3” according to expression (4). As a result, the table indexes corresponding to hash value “1” and hash value “3” are calculated as “1” and “3”, respectively.

Hence, the management section 320a registers key “9” at the table index 1 of the internal hash table 330a and registers key “11” at the table index 3 of the table.

The management section 320a deletes the internal hash table 330c (at S11) and deletes the last table number 2 in the table management table 320b (at S12).

In the above-mentioned case, the process is described up to when the internal hash table 330c is deleted. However, it may be possible that the internal hash table to be deleted and the keys linked thereto are not deleted immediately but the table may remain as a “table to be deleted”.

For example, in the case described above, the management section 320a leaves the internal hash table to be deleted as a table to be deleted. With respect to data to be stored in the table size history table 320c, the management section 320a stores total table size “12” before deletion as the total table size before deletion.

In the case of referring to key “9” and key “11”, the management section 320a refers to key “9” and key “11” using total table size “12” before deletion. The management section 320a reregisters key “9” at the table index 1 of the internal hash table 330a and registers key “11” at the table index 3 of the table.

After the data registered in the internal hash table 330c is deleted, the management section 320a deletes the table and frees the memory used for the table.

The management section 320a deletes the table number 2 linked to the internal hash table 330c and frees the memory used for the table number 2.

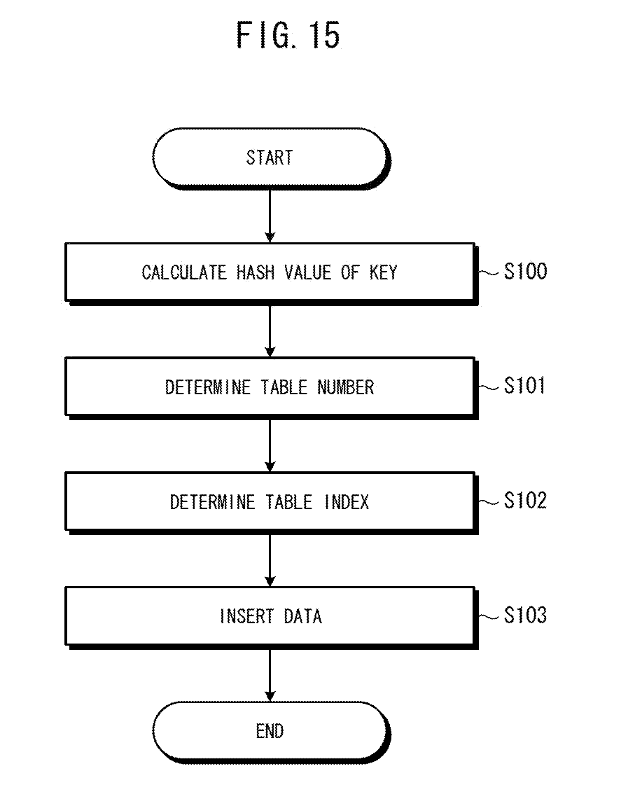

Next, a procedure to be executed by the information processing unit 300 at the time of data addition will be described below. FIG. 15 is a flowchart illustrating the procedure to be executed at the time of data addition.

The information processing unit 300 receives a key addition instruction from the application program 60 and calculates the hash value of a key to be registered using the hash function H(k) (at S100).

The information processing unit 300 determines the table number corresponding to the key using the hash value calculated at S100 and a hash function h1(k) (at S101). The information processing unit 300 determines the table index corresponding to the key using the hash value calculated at S100 and a hash function h2(k) (at S101).

The information processing unit 300 adds a key to a pointer of an internal hash table to be registered based on the calculated table number and the table index (at S103).

According to this flowchart, since the key is added, even if the total table size is changed, the recalculation of all the hash values associated with the change in the total table size is not executed immediately, and restructuring of the hash tables is not executed either. Hence, it is possible to avoid the concentration of processes required for the recalculation of the hash values.

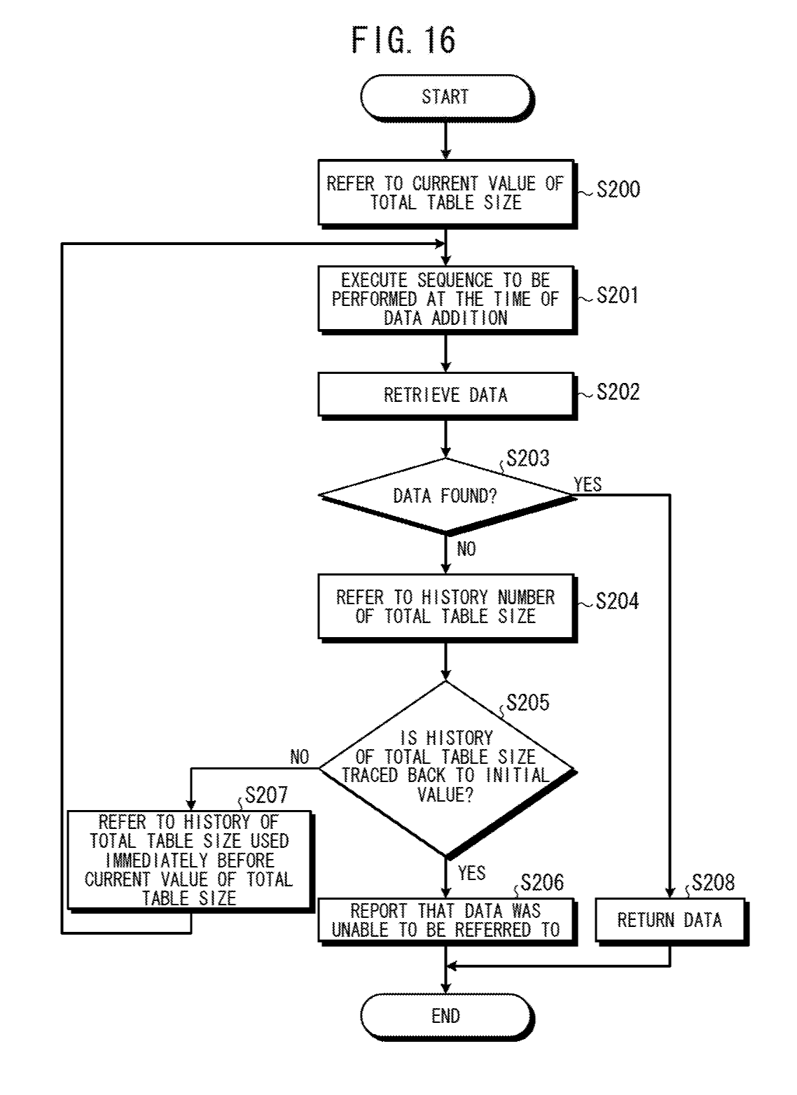

Next, a procedure to be executed by the information processing unit 300 at the time of data reference will be described below. FIG. 16 is a flowchart illustrating the procedure to be executed at the time of data reference.

First, the information processing unit 300 receives a data reference instruction from the application program 60 and refers to the history data at the end of the table size history table 320c (at S200).

The information processing unit 300 executes the sequence ranging from S100 to 102 illustrated in FIG. 15 for the key of data to be referred to (at S201). The information processing unit 300 retrieves data based on the reference position of the key determined at S201 (at S202).

When information processing unit 300 is unable to find data at the reference position of the key determined at S201 (No at S203), the information processing unit 300 refers to the history number of the table size history table 320c (at S204).

At this time, if the history number referred to by the information processing unit 300 is the initial value 0 (Yes at S205), it is understood that data has been retrieved while the history number is traced back to its initial value, and the information processing unit 300 issues a report to the effect that data was unable to be referred to (at S206).

On the other hand, if the history number referred to by the information processing unit 300 is not the initial value 0 (No at S205), the information processing unit 300 refers to the history of the total table size used immediately before the total table size referred to at S200 (at S207), and the procedure returns to S201.

Furthermore, when the information processing unit 300 has found data at the reference position of the key determined at S201 (Yes at S203), the information processing unit 300 returns the retrieved data to the application program 60 (at S208).

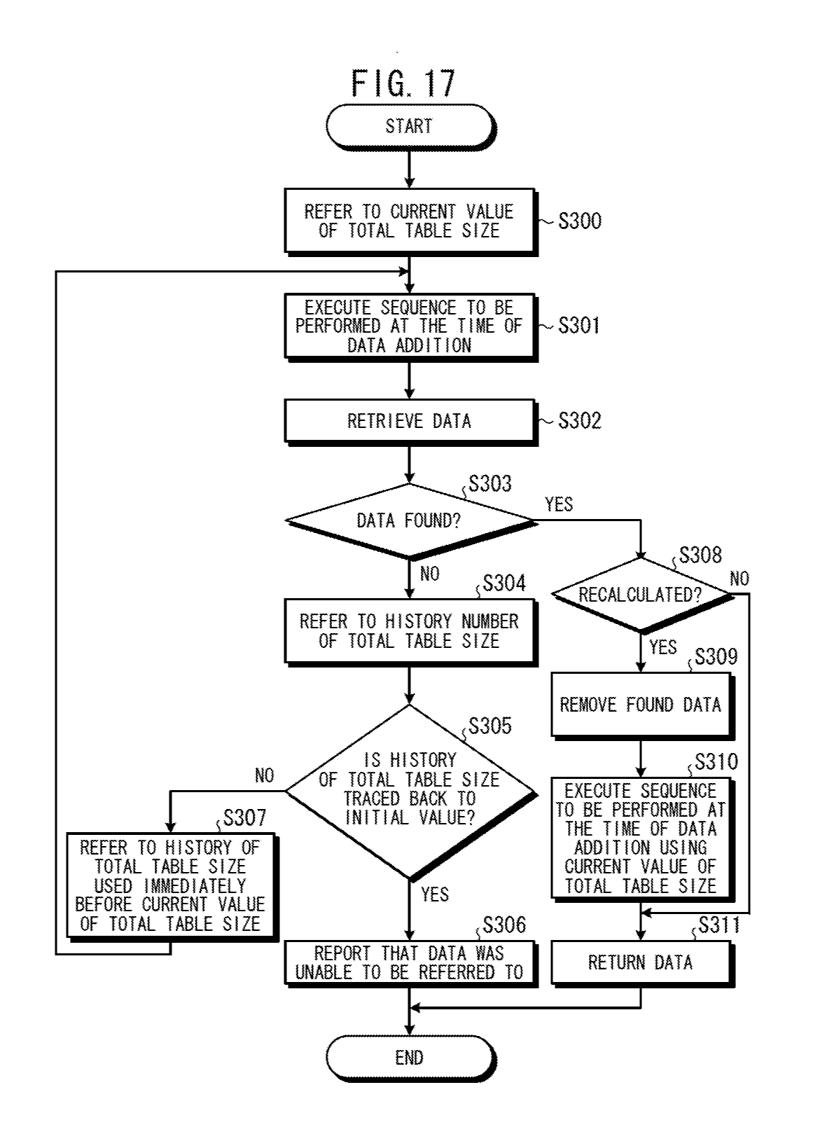

Next, a procedure to be executed by the information processing unit 300 at the time of data movement will be described below. FIG. 17 is a flowchart illustrating the procedure to be executed at the time of data movement.

The information processing unit 300 receives a data reference instruction from the application program 60 and refers to the history data at the end of the table size history table 320c (at S300).

The information processing unit 300 executes the sequence ranging from S100 to S102 illustrated in FIG. 15 for the key of data to be referred to (at S301). The information processing unit 300 retrieves data based on the reference position of the key determined at S301 (at S302).

When the information processing unit 300 is unable to find data at the reference position of the key determined at S301 (No at S303), the information processing unit 300 refers to the history number of the table size history table 320c (at S304).

At this time, if the history number referred to by the information processing unit 300 is the initial value 0 (Yes at S305), it is understood that data has been retrieved while the history number is traced back to its initial value, and the information processing unit 300 issues a report to the effect that data was unable to be referred to (at S306).

On the other hand, if the history number referred to by the information processing unit 300 is not the initial value 0 (No at S305), the information processing unit 300 refers to the history of the total table size that was used immediately before the total table size referred to at S300 (at S307), and the procedure returns to S301.

The information processing unit 300 retrieves the reference position of the key determined by the total table size used immediately before the total table size referred to at S300 (at S302), and when the information processing unit 300 is able to find data (Yes at S303), the procedure advances to S308.

When the recalculation of the hash value corresponding to the key of the data found at S303 has been executed (Yes at S308), the information processing unit 300 removes the found data (at S309), executes the sequence to be performed at the time of data addition using the total table size referred to at S300 (at S310), and returns the data to the application program 60 (at S311).

On the other hand, when the recalculation of the hash value corresponding to the key of the data found at S303 has not been executed (No at S308), the procedure advances to S311.

According to this flowchart, the retrieval position of the data referred to by the recalculation of the hash value may be moved depending on the newest total table size. Hence, when the same data is retrieved again, the calculation of the hash value is performed only once.

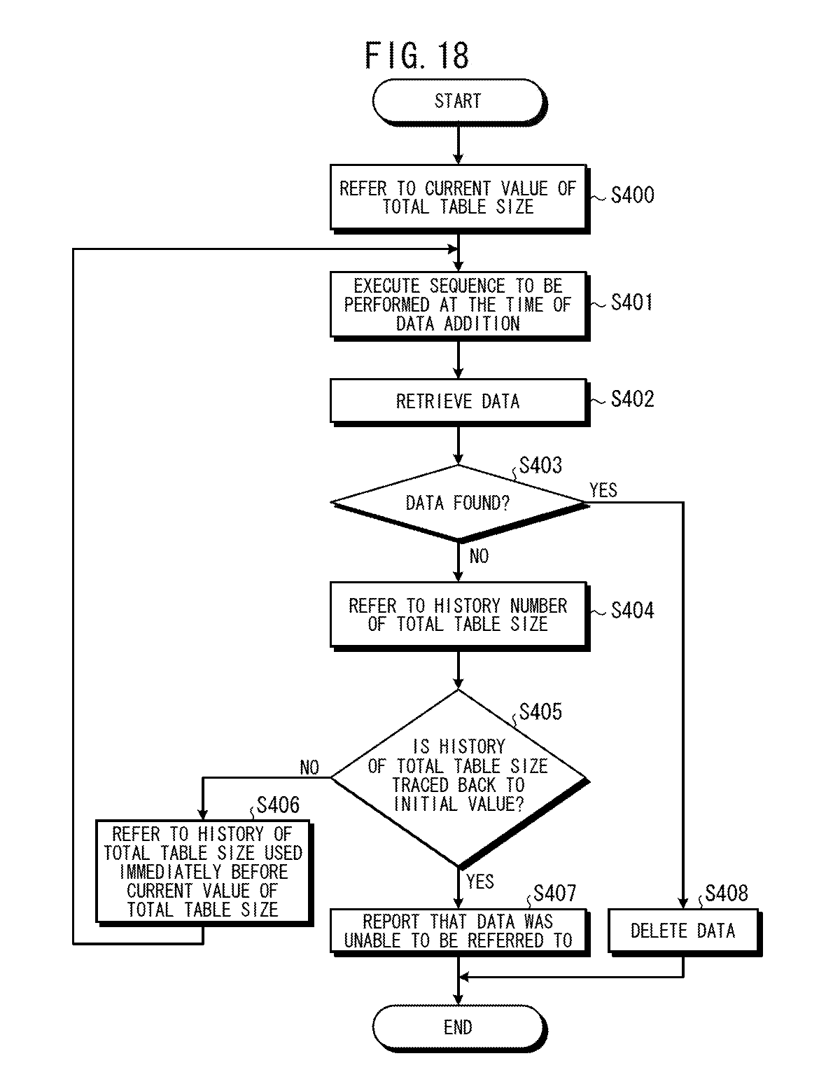

Next, a procedure to be executed by the information processing unit 300 at the time of data deletion will be described below. FIG. 18 is a flowchart illustrating the procedure to be executed at the time of data deletion.

First, the information processing unit 300 receives a data deletion instruction from the application program 60 and refers to the history data at the end of the table size history table 320c (at S400).

The information processing unit 300 executes the sequence ranging from S100 to 102 illustrated in FIG. 15 for the key of data to be deleted (at S401). The information processing unit 300 retrieves data based on the reference position of the key determined at S401 (at S402).

When the information processing unit 300 is unable to find data at the reference position of the key determined at S401 (No at S403), the information processing unit 300 refers to the history number of the table size history table 320c (at S404).

If the history number referred to by the information processing unit 300 is the initial value 0 (Yes at S405), it is understood that data has been retrieved while the history number is traced back to its initial value, and the information processing unit 300 issues a report to the effect that data is unable to be referred to (at S407).

On the other hand, if the history number referred to by the information processing unit 300 is not the initial value 0 (No at S405), the information processing unit 300 refers to the history of the total table size used immediately before the total table size referred to at S400 (at S406), and the procedure returns to S401.

Furthermore, when the information processing unit 300 has found data at the reference position of the key determined at S401 (Yes at S403), the information processing unit 300 deletes the retrieved data (at S408).

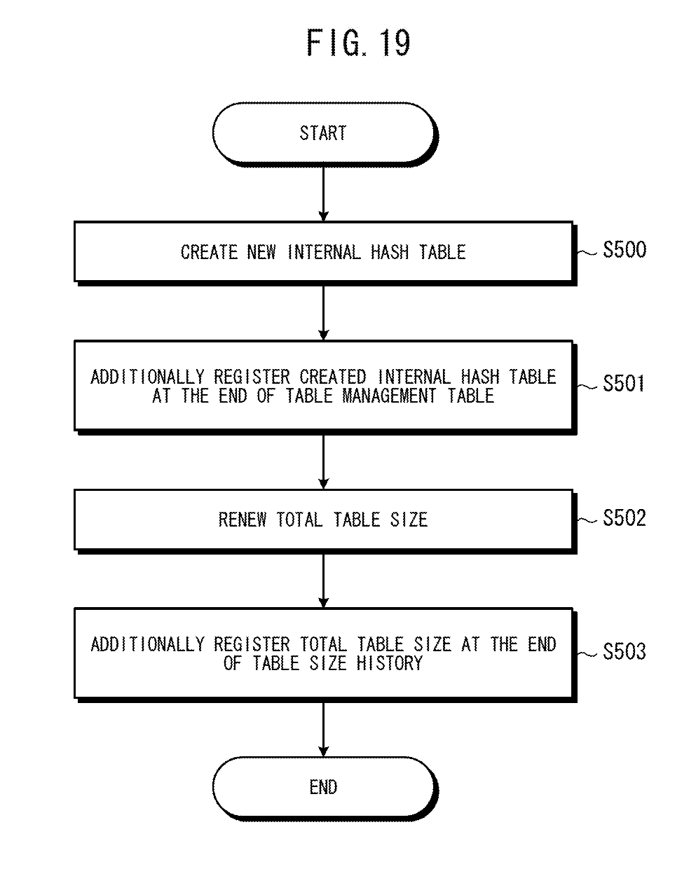

Next, a procedure to be executed by the information processing unit 300 at the time of expanding the total table size will be described below. FIG. 19 is a flowchart illustrating the procedure to be executed at the time of expanding the total table size.

The information processing unit 300 receives an instruction for expanding the total table size from the application program 60 and newly creates an internal hash table having a unit table size of 4 (at S500).

The information processing unit 300 additionally registers the internal hash table created at S500 at the end of the table number in the table management table 320b (at S501).

The information processing unit 300 renews the total table size of the internal hash tables therein (at S502). The information processing unit 300 adds the newest total table size at the end of the table size history table 320c (at S503).

According to this flowchart, the information processing unit 300 newly adds an internal hash table, whereby the total table size may be expanded without restructuring the hash tables.

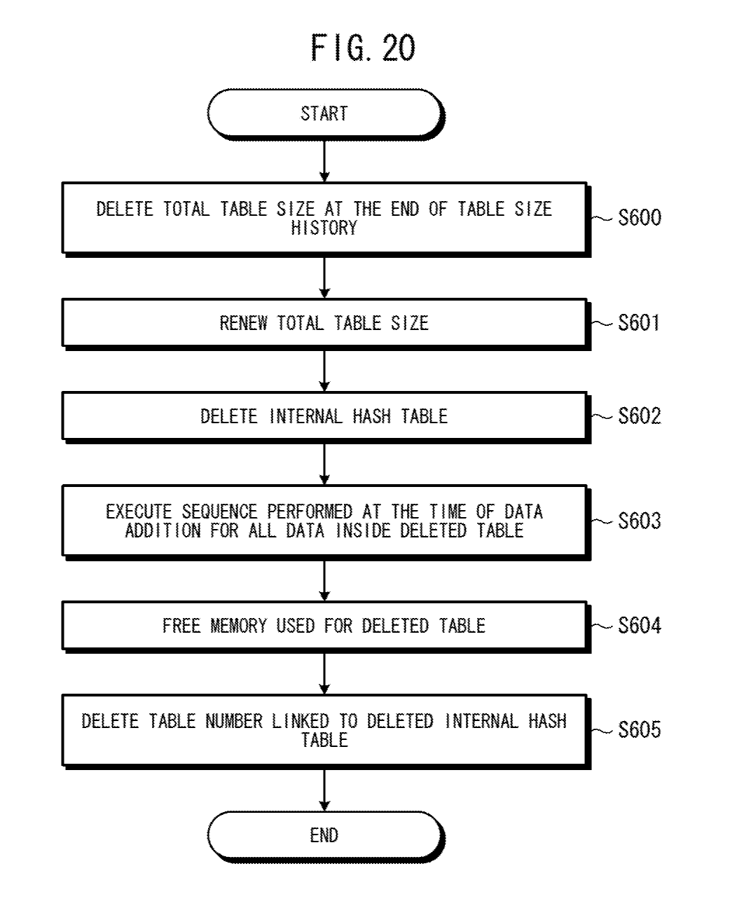

Next, a procedure to be executed by the information processing unit 300 at the time of reducing the total table size will be described below. FIG. 20 is a flowchart illustrating the procedure to be executed at the time of reducing the total table size.

The information processing unit 300 receives an instruction for reducing the total table size from the application program 60 and deletes the total table size registered at the end of the table size history table 320c (at S600).

The information processing unit 300 renews the total table size of the internal hash tables therein (at S601).

The information processing unit 300 deletes the internal hash table 330c (at S602) and executes the sequence ranging from S100 to S102 illustrated in FIG. 15 for the keys registered in the deleted internal hash table 330c (at S603).

The information processing unit 300 frees the memory used for the deleted internal hash table (at S604) and deletes the table number corresponding to the deleted internal hash table (at S605).

According to this flowchart, the information processing unit 300 may delete an internal hash table in accordance with data to be registered. As a result, wasteful consumption of the memory resource may be reduced if not prevented.

As described above, the information processing unit 300 disclosed in the present invention may change the total table size of the internal hash tables therein depending on the amount of data to be used in the internal hash tables. As a result, wasteful consumption of the memory to be used for the internal hash tables may be reduced if not prevented.

Furthermore, when the information processing unit 300 refers to keys without immediately recalculating the hash values associated with the change in the total table size, the information processing unit may execute recalculation. Hence, the concentration of processes required for the recalculation of the hash values may be avoided, and the worst value of the processing time specified by SLA may be reduced.

With the use of the chain method, in the case of retrieval of the list of keys registered in the table indexes of each respective hash table, when it is assumed that the length of the list is “m”, the reference time for the retrieval is represented by O(m). As the total table size increases, data to be registered in the same list is dispersed, whereby the value of “m” becomes smaller.

Conventionally, as data is added and as the table size becomes larger, the time for retrieval takes longer. However, in the information processing unit 300 disclosed in the embodiment, the time for data retrieval may be reduced.

Among the processes having been described in the embodiment, all or part of the processes having been described as being performed automatically may also be performed manually. Conversely, all or part of the processes having been described as being performed manually may also be performed automatically by a known method. In addition, the information including the processing procedures, control procedures, specific names, and various kinds of data, described above and illustrated in the figures, may be changed as desired, except when noted otherwise.

Furthermore, the functions of the components of the information processing unit 300 illustrated in FIG. 2 are conceptual, and the information processing unit is not always required to be configured physically as illustrated in the figures. In other words, the specific dispersion/integration forms of the respective components are not always limited to those illustrated in the figures, but may be configured by dispersing/integrating all or part of the components functionally or physically in any desired units depending on various kinds of loads and usage conditions.

For example, the functions of the information processing unit 300 are not required to be provided inside the same terminal, but the internal hash tables thereof may be disposed in separate servers connected via a communication function. A specific configuration will be described below.

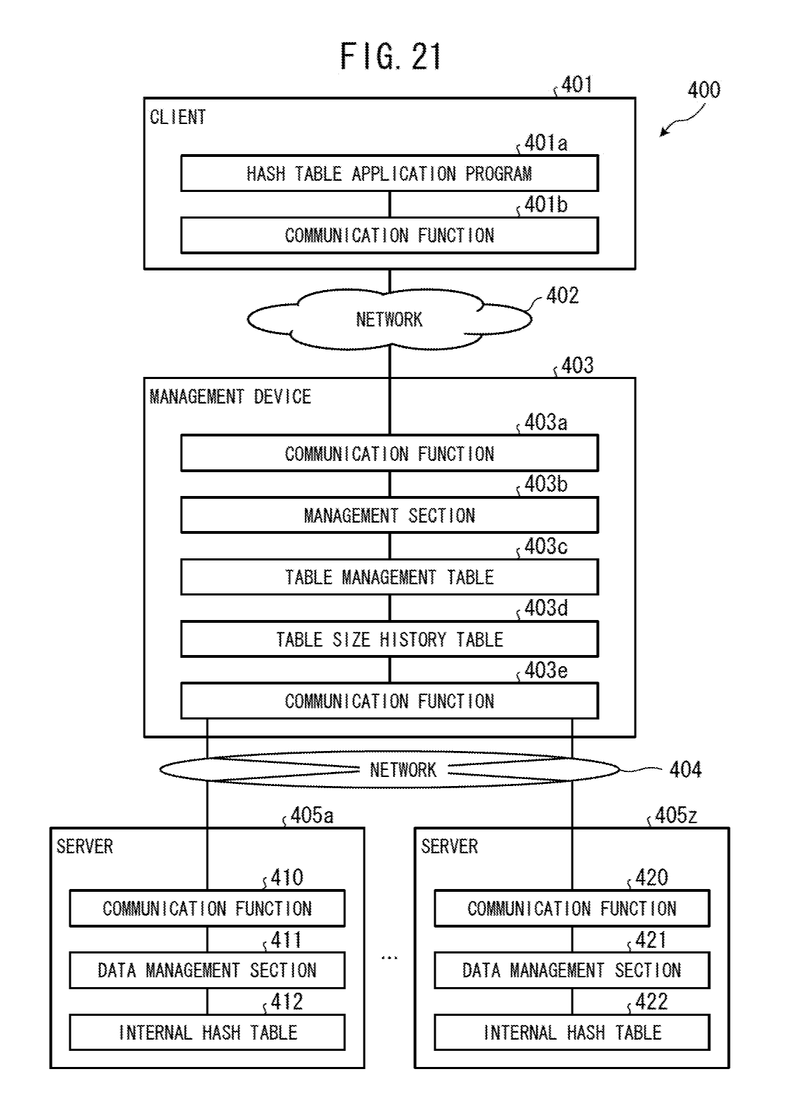

FIG. 21 is a functional block diagram illustrating the configuration of a system for attaining data management using the hash method. The system 400 illustrated in FIG. 21 performs a function similar to the function of the information processing unit 300 illustrated in FIG. 2 and has a client 401, a network 402, a management device 403, a network 404, and servers 405a to 405z.

The client 401 is a device that requests the management device 403 to perform data reference, etc. and includes a hash table application program 401a and a communication function 401b. The client 401 corresponds to the application program 60 illustrated in FIG. 2.

The communication function 401b is an interface for performing data processing with the management device 403 via the network 402.

The network 402 is a network for establishing connection between the client 401 and the management device 403.

The management device 403 is a device for processing various kinds of data and for managing the data of the internal hash tables in the servers 405a to 405z in response to the requests from the client 401 and includes a communication function 403a, a management section 403b, a table management table 403c, a table size history table 403d, and a communication function 403e.

The communication function 403a serves as an interface for outputting instructions for processing various kinds of data from the client 401 to the management section 403b via the network 402, and when data is input from the management section 403b, the communication function 403a serves as an interface for sending a data response to the client 401. Furthermore, the communication function 403a corresponds to the interface 310 illustrated in FIG. 2.

The management section 403b corresponds to the management section 320a illustrated in FIG. 2 and is a processing section for responding to various kinds of processing instructions input from the communication function 403a. Furthermore, the management section 403b performs data processing and hash calculation for the table management table 403c depending on the various kinds of processing instructions and manages the data of the table size history table 403d.

The table management table 403c corresponds to the table management table 320b illustrated in FIG. 3. The table management table 403c has table numbers in which the internal hash tables possessed by the servers 405a to 405z are registered and manages the table numbers.

The table size history table 403d corresponds to the table size history table 320c illustrated in FIG. 3 and stores the history of the total amount of memory of the internal hash tables possessed by the servers 405a to 405z. Furthermore, the management section 403b performs data renewal.

The communication function 403e serves as an interface for exchanging the processing of the data of the servers 405a to 405z via the network 404.

The network 404 is a network for establishing connection between the management device 403 and the servers 405a to 405z.

The servers 405a to 405z each have an internal hash table for storing keys and data linked to the keys in response to the request from the client 401, and the internal hash table of each server corresponds to the internal hash table 330a illustrated in FIG. 2. Among the plurality of servers of the system 400, the server 405a is taken as an example and described below.

The server 405a is a device for storing various kinds of data to be used by the client 401 and has a communication function 410, a data management section 411, and an internal hash table 412.

The communication function 410 serves as a processing section for exchanging data with the management device 403 via the network 404 and receives keys and data linked to the keys from the management device 403 in response to the request from the client 401.

The data management section 411 registers data received by the communication function 410 in the internal hash table 412. It is assumed that positions in which the data is registered are obtained by the management section 403b.

It is assumed that the internal hash table 412 is a hash table for storing various kinds of data to be used by the client 401 and keys for identifying the various kinds of data and corresponds to the internal hash table 330a illustrated in FIG. 2.

In addition, the internal hash table 412 has table indexes corresponding to pointers in which keys and various kinds of data of the keys are registered, and the keys are registered in the specific table indexes.

Furthermore, the server 405z illustrated in FIG. 21 has a function similar to that of the above-mentioned servers 405a. More specifically, the servers 405z has a communication function 420 corresponding to the communication function 410, has a data management section 421 corresponding to the data management section 411, and has an internal hash table 422 corresponding to the internal hash table 412.

The hash function H(k) used in the embodiment may only be a function obtained from the values of keys and the total table size and may not always be limited to the above-mentioned expression (2).

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A recording medium storing a program that causes a processer to execute a procedure, the procedure comprising:
calculating registration positions of data based on a total amount of data of existing tables and a hash method, and registering the data at the registration positions, when registering the data in a plurality of tables;
adding or deleting the table;
calculating the registration position of the data based on the total amount of data of the existing tables and the hash method and judging whether data to be referred to is present at the registration position, when data registered in a table is referred to after the table is added or deleted; and
when the data to be referred to is not present at the registration position, recalculating the registration position of the data.

2. The recording medium storing a program, according to claim 1, that causes a processer to execute a procedure further comprising:
moving the data registered at the recalculated registration position to the registration position calculated before the recalculation, when the registration position of the data is recalculated.

3. The recording medium storing a program, according to claim 1, that causes a processer to execute a procedure further comprising:
recording history information of the total amount of data of the existing tables, wherein the recalculation section recalculates the position of the data based on the history information.

4. An information processing unit comprising:
a registration section that calculates registration positions of data based on a total amount of data of existing tables and a hash method, and that registers the data at the registration positions, when registering data in a table; and
a table management section for adding or deleting the table.

5. An information processing system having a memory device and a table creating device, the table creating device comprising:
a registration section that calculates registration positions of data based on a total amount of data of existing tables and a hash method and that registers the data at the registration positions, when registering data in a plurality of tables in the memory device;
a table management section for adding or deleting the table;
a judging section, that calculates the registration position of the data based on the total amount of data of the existing tables and the hash method, and that judges whether data to be referred to is present at the registration position, when data registered in a table is referred to after the table is added or deleted using the table management section; and
a recalculation section that recalculates the registration position of the data when the data to be referred to is not present at the registration position.
